(19) United States
(12) Patent Application Publication
(10) Pub. No.: US 2025/0045833 A1
(43) Pub. Date: Feb. 6, 2025

(54) METHOD FOR THE OPTIMIZATION OF A PORTFOLIO

(71) Applicant: KIPU QUANTUM GMBH, Karlsruhe (DE)

(72) Inventors: Enrique Solano, Berlin (DE); Narendra Hegade, Bengaluru (IN); Iraitz Montalban, Karlsruhe (DE)

(21) Appl. No.: 18/717,573

(22) PCT Filed: Dec. 9, 2022
(86) PCT No.: PCT/EP2022/085196

§ 371 Date: Jun. 7, 2024

(30) Foreign Application Priority Data
Dec. 9, 2021 (EP) 21213435.7

(51) Int. Cl. G06Q 40/06

(52) U.S. Cl. CPC G06Q 40/06

(57) ABSTRACT

The invention relates to a method, to a computer program and to a computer device as described herein. A computer-implemented method for solving a portfolio optimization problem includes encoding the portfolio optimization problem into an Ising-Hamiltonian model whose ground state is the optimal solution of the problem, providing a cost function, providing constraints for the cost function, applying a digitized counterdiabatic driving method to a Hamiltonian encoding the cost function, and providing a parameterized circuit design with a minimum depth to a counterdiabatic accelerated adiabatic evolution.

The invention relates to a method for the design of circuits for combinatorial optimization problems, such as the optimization of a portfolio. Specifically, the invention is defined by the appended independent claims. Embodiments of the invention are defined in the dependent claims.

### DESCRIPTION

The object of the present invention is to provide a way to create parameterized quantum circuits to be used for combinatorial optimization problems, in particular for the optimization of a portfolio.

This object is achieved by the invention which provides a method to create application and hardware specific parameterized quantum circuits for portfolio optimization.

A method in the form of a classical reinforcement learning method with which a parameterized quantum circuit is designed specifically suited to solve combinatorial optimization problems for the finance industry.

The problem is defined in that an asset manager is willing to invest a budget b in a given portfolio with n number of assets (stocks etc.), the so-called portfolio. It is to be determined how to distribute the given budget b into n assets such that the asset manager would receive maximum returns at minimum risk.

Optimization problems are of interest due to their fundamental applications in many fields such as logistics, aeronautics, finance, among others. Nevertheless, due to their computational complexity, they cannot be solved efficiently using classical computers for industrial purposes.

It is known that a quantum computer can surpass the capabilities of a classical one, and due to the experimental developments during the last years, it is useful for commercial purposes.

These experimental developments have boosted the theoretical proposal of several algorithms in different areas such as differential equations, linear algebra, and optimization problems, which have been implemented in small quantum computers for toy problems as proof of principle. However, the advantage and the applicability of many of these algorithms in the current noisy intermediate-scale quantum (NISQ) devices is still under investigation, due to the impossibility to implement error correction protocols with the current and near future devices, which is a fundamental issue for the current paradigm of full tolerant quantum computing.

In recent years, the use of adiabatic quantum optimization (AQO) algorithms to solve optimization problems has received interest due to its experimentally feasible implementation.

These algorithms solve optimization problems by encoding the solution of a simpler problem whose ground state (minimum energy state) is easy to find. Evolving it via adiabatic evolution to the target problem Hamiltonian whose minimum energy state (ground state) is the solution to the optimization problem. The invention provides a way to efficiently solve the problem on a quantum device. Current technology allows the implementation of incoherent adiabatic quantum computers or quantum annealers with thousands of qubits. Nevertheless, due to the considerable time involved in an adiabatic evolution, such devices have various limitations affecting the overall performance, like noise or unwanted artifacts introduced during the evolution or limited qubit-connectivity, making complicated to adapt the original problem to a Hamiltonian evolution that would fit in such devices.

To overcome these limitations, the use of digitized adiabatic quantum computing methods emerged. These methods are similar to AQO, but they digitized the evolution to implement it in a gate-based quantum computer. The advantage of digitizing is that any arbitrary interactions can be included in the problem Hamiltonian which gives more flexibility in choosing the optimization problem. However, it requires many gates, which reduce the fidelity of the algorithms being impractical to get some advantage in NISQ devices.

Other types of algorithms to solve optimization problems are the hybrid quantum-classical gate-based quantum algorithms like the quantum approximate optimization algorithm (QAOA).

In QAOA, a sequence of two evolutions is applied iteratively to an initial state, where each evolution time is a parameter to be optimized to minimize a cost function that encodes the problem. One of these evolutions is governed by a mixing Hamiltonian which is usually a x gate applied to all the qubits, and the other is generated by a Hamiltonian that codify the cost function. Finally, the elapsed time of each evolution is optimized by a classical algorithm.

Although QAOA is simple, it presents some major problems like the number of layers (repetitions of the two basic evolutions) required to optimize the cost function that in general is huge for many-body Hamiltonians, being not suitable for current NISQ devices. Also, classical optimization does not guarantee to reach the global minimum every time as it can get stuck into a local minimum, or there might be the existence of barren plateaus.

To overcome these general limitations found in all previous techniques, shortcuts to adiabaticity (STA) methods can be used. These methods improve the adiabatic processes by circumventing the need of slow driving. This additional driving controls the time evolution in those settings so that it can be accelerated in a controlled manner to avoid losing the adiabatic nature and ending on a completely random solution.

STA includes methods like fast-forward, inverse engineering, counterdiabatic (CD) driving, etc.

Among these, counterdiabatic (CD) driving, meaning the addition of an extra term to the original two described for adiabatic evolution (initial Hamiltonian and problem Hamiltonian), suppresses the non-adiabatic transitions showing improvements in adiabatic quantum computing and quantum annealing.

CD driving in Digitized Counterdiabatic Quantum Computing-methods shows improvements in factorization problems against the digitized adiabatic quantum computing paradigm.

By setting a procedure with which different combination of CD terms and original Hamiltonians are combined, the circuit is optimized so that the final computer-aided design meets similar performance to Digitized Counterdiabatic Quantum Computing but aiming for a minimal circuit depth. By this method, one reduces the performance detriment of deep circuits in current quantum hardware.

In the examples, the advantages of these methods are shown. Many instances of data were selected and the problems were solved using the Digitized Adiabatic Quantum Computing with CD driving.

In some embodiments of the invention, the problem could be solved using a minimal version only composed by CD driving terms, and the results are compared with QAOA and the Digitized Adiabatic Quantum Computing with CD driving to show that the inclusion of CD driving gives major advantages over adiabatic methods.

In the specific case of portfolio optimization, it is supposed that an asset manager is willing to invest a budget b in a given subset of available assets (n). Markowitz's portfolio optimization answers the question: How to distribute the given budget b into n assets such that the asset manager would receive maximum returns at minimum risk.

For example, the asset manager could invest evenly in all the assets, but that may not be the best choice. Given the expected returns of each asset xᵢ and the risk associated with the assets, applying Markowitz portfolio optimization, the distribution of the budget b can be predicted to get the maximum returns out of the portfolio. Expected returns can be estimated out of the preceding market return data and the risk is assessed via a covariance matrix. As the name suggests, a covariance matrix shows the covariance of different stocks in the portfolio. Thus, these types of problems are classified as mean-variance portfolio optimization problems.

In general, the portfolio optimization problem has two components, the cost function or target to optimize (take it to its maxima or minima) and the constraints affecting it.

The cost function basically includes quantities such as the average returns, variance of the portfolio, etc. that needs to be maximized or minimized based upon the need of the asset manager and the constrains that can include budget constrain or transition costs or market inflation etc.

Based on the types of constraints, the portfolio optimization problems that can be solved by the present invention can be broadly divided into three types:
1. the optimization problem is the “unconstrained” portfolio optimization where the constrains are added as the penalty terms in the cost function with the help of Lagrangian multipliers.
2. when the constraints are positivity constraints that can be represented by inequalities.
3. when the constraints are the integer constraints, so-called the mixed integer problem (MIP).

As far as the variables are concerned, portfolio optimization can be solved as both a continuous variable problem and discrete variable problem.

Discrete mean-variance optimization proves to be a beneficial method to optimize the given portfolio in cases where the assets are traded in lots. Lots are integer multiples of a base size of assets that can be traded. Thus, an asset manager will only be interested in number of lots which makes the problem discreet. Based on this, an unconstrained single-period discreet mean-variance portfolio optimization problem to find using the digitized counterdiabatic driving methods is investigated here.

The task is to distribute b budget into n assets with mean returns mᵢ and the co-variance matrix ponto maximize returns at a minimum variance. The problem can be formulated as

$${max}_{x} {\sum }_{i = 1}^{n} {θ}_{1} {m}_{i} {x}_{i} - {θ}_{2} {ρ}_{ij} {x}_{i} {x}_{j} - {{θ}_{3} ( {G}_{f} {bx}_{i} - b )}^{2} \qquad ( 1 )$$

where xᵢ are the assets represented by integers. The first term of equation (Eq.) 1 shows the expected returns and the second term shows the variance of the portfolio. The market data (mᵢ's and ρᵢⱼ's) i.e. the daily returns data or the co-variance matrix, can be generated in various ways. The third term shows the hard constraint applied to the budget. This term penalizes the solutions that do not satisfy the budget criteria. The term G_{f} in Eq. 1 shows the granularity function which is given by G_{f}=½^{(g-1)} where g is the number of slices of the budget. This implies that the fraction of the budget that can be chosen is G_{f}bxᵢ. To explain this, assume that g=2, so the budget is cut into two slices giving G_{f}=½. Therefore, b/2 weight of the budget can be invested in required assets. In other words, the granularity function shows how small a fraction of b you can invest in of a particular stock. Thus, with increasing the value of the slice g, one gets the freedom to invest smaller fractions of the budget which will result in more precision while deciding the stock weights. θ₁, θ₂ and θ₃ are the Lagrangian multipliers. The role of Lagrangian multipliers is to adjust weights of different terms to adjust constraints according to the particular requirements.

To solve this problem, the next task would be to transform Eq. 1 into an Ising Hamiltonian. This can be done by encoding assets xᵢ integers into an g bit binary number. It is worthwhile here to mention that binary encoding is not the only type of encoding, various ways of encoding like unary, sequential, partition may be used. Hence, xᵢ's are given by

$${x}_{i} = {\sum }_{k = 1}^{g} {2}^{k - 1} {z}_{u ( i , k )} \qquad ( 2 )$$

where u(i,k)=(i−1)k+g and z∈{0, 1}. This problem can be transformed into a quadratic unconstrained optimization problem (QUBO) after making some rearrangements,

$${H}_{QUBO} = {min}_{𝓏} ( {\sum }_{i}^{N} {μ}_{i} {𝓏}_{i} + {\sum }_{i , j}^{N} {Q}_{i , j} {𝓏}_{i} {𝓏}_{j} + γ ) \qquad ( 3 )$$

where N=n*g. This QUBO instance can be turned into an Ising Hamiltonian simply by the transformation

$${𝓏}_{i} = \frac{1}{2} ( 1 + {σ}_{i}^{𝓏} ) , \qquad ( 4 )$$

$${H}_{p} = {\sum }_{i} {h}_{i} {σ}_{i}^{𝓏} + {\sum }_{i , j} {J}_{ij} {σ}_{i}^{𝓏} {σ}_{j}^{𝓏} + β$$

with,

$${J}_{i , j} = \frac{1}{4} ( {θ}_{2} {b}^{2} {G}_{f}^{2} + {θ}_{3} {ρ}_{i , j} ) , \qquad ( 5 )$$

$${h}_{i} = \frac{( - {θ}_{1} {m}_{i} - 2 {θ}_{2} {b}^{2} {G}_{f}^{} )}{2} + {\sum }_{j} {J}_{i , j}$$

with a constant β that can be ignored.

The portfolio optimization problem is encoded into an Ising Hamiltonian whose ground state will be the optimal solution of the given problem.

In one aspect, the invention refers to a method as described above and herein.

In one embodiment, the invention refers to a method, in particular a computer-implemented method, for designing and solving an optimization problem, in particular for solving a portfolio optimization, comprising the step of encoding the portfolio optimization problem into an Ising Hamiltonian whose ground state is the optimal solution of the problem.

In one embodiment, the invention refers to a method, in particular a computer-implemented method, for designing and solving an optimization problem, in particular for solving a portfolio optimization, comprising the following steps:
providing a cost function for portfolio optimization problems,
providing constraints for the cost function that are encoded in the cost function,
performing a digitized counterdiabatic driving method to the Ising Hamiltonian encoding the cost function, and
providing a parameterized circuit design, in particular with minimum depth, in particular to (counter-diabatically) accelerate the adiabatic evolution, and
starting a time evolution until the ground state of the Ising-Hamiltonian is found, i.e. the solution. The solution may be presented to the user of the computer-implemented method.

In certain embodiments, the cost function encodes parameters of portfolio optimization return, risk and budget data into a canonical QUBO form, thereby representing the problem Hamiltonian as the cost function to the optimization problem.

In certain embodiments, the invention refers to a method, wherein the optimization problem is an unconstrained single-period discreet mean-variance portfolio optimization problem.

In certain embodiments, the invention refers to a method wherein the constraints for the cost function are encoded into the cost function regularized by Lagrangian operators, in particular restricting how the constraints need to be hardened to assume a higher or lower risk on the final result.

In certain embodiments, the invention refers to a method wherein at least one or more Lagrangian multipliers are used to adjust the weight of a term. In particular, the term may comprise coefficients scaling the relevance of the budget constraint with respect to risk and revenue factors.

Such a term may be a way to embed and modulate the effect of constraints when included in the objective function to be optimized as explained before.

In certain embodiments, the invention refers to a method wherein the computation of the Nested Commutator is used to obtain the CD term and associated coefficients which can provide a significant gain in the quality of the solutions such as success probability or approximation ratio, while maintaining a shallow circuit depth. The Nested Communicator Commutator may be chosen from the group consisting of terms composing the initial Hamiltonian (X term), terms of the problem Hamiltonian (Z and ZZ terms) and terms of the CD term pool composed of all one and two term combinations originated by combining Pauli operators (X, Y, and Z).

In certain embodiments, the invention refers to a method, wherein the optimization problem is transformed into a quadratic unconstrained optimization problem (QUBO as in equation 3). Two possible solutions may be found or provided with two different values for a given variable. A new binary variable is defined that selects between the two different values. This can then be reduced to a Quadratic Unconstrained Binary Optimization (QUBO) problem that may be optimized. In some implementations, the resulting QUBO problem may be sent to a quantum processor, and solutions may be generated using quantum annealing. A classical or digital computer may use, for example, Cross-Boltzmann updates to build a binary problem that may then be solved by the quantum computer. Cross-Boltzmann updates use the energy associated with updating two variables, both individually, and dependent on one another, to provide a Hamiltonian that expresses the decision whether to update those two variables. The digital processor may select two candidate values and may then send this update to the quantum processor as an optimization problem.

In certain embodiments, the method additionally comprises the steps of
starting with an initial Hamiltonian and
turning on a problem Hamiltonian in an adiabatic way to drive the search for the ground state, and
optionally, modulating the adiabatic driving.

In one embodiment, the invention refers to a method, in particular according to any of the preceding claims, wherein the optimization problem is encoded into an Ising Hamiltonian whose ground state is the optimal solution of the problem by means of reinforcement learning routines. Reinforcement learning routines may be, for example, Monte Carlo tree search (MCTS).

In one embodiment, Ising and QUBO Hamiltonians can be used in same manner to represent the same problem encoded into different variable regimes. QUBO requires variables to be binary {0,1}while Ising requires them in {−1, 1}values.

In one embodiment, the invention refers to a method, in particular according to any of the preceding claims, comprising the steps of
starting with an initial Hamiltonian encoding the optimization problem to be solved and
turning on a problem Hamiltonian while turning off the initial Hamiltonian in an adiabatic manner in order to reach the final Hamiltonian, i.e. the solution.

In one embodiment, the invention refers to a method, in particular according to any of the preceding claims, wherein
at least one (or more, such as, for example, two, three or four) counterdiabatic driving term(s) (CD term) is/are introduced for compensating the excitations that occur due to the finite time evolution, so that the resulting evolution is so-called quasi-adiabatic.

In one embodiment, the invention refers to a method, in particular according to any of the preceding claims, wherein the counterdiabatic driving term is term composed of a composition of Pauli operators approximating the obtained CD term by the NC approach.

A counterdiabatic driving term is of higher-order if it relates to the relationship between more than two indexes from the problem setup. The problem setup being of quadratic nature (up to two x variables interacting at each time, encoding three-way interactions (ex: xⱼxᵢxₖ) would not be realizable in the target hardware.

In one embodiment, the invention refers to a method, wherein the higher-order counterdiabatic driving term is obtained by a nested commutator (NC) approach.

A nested commutator (NC) approach is the one that allows for the analytical definition of the CD terms for a specific setup of a problem, such as it is the case of portfolio optimization, and its given time-dependent Hamiltonian present in the Digitized Counterdiabatic Quantum Computing processes explained before.

In further embodiments, the invention refers to a method wherein
a digitized-counterdiabatic inspired PQC (DC-ansatz) and/or
a quantum approximate optimization algorithm (QAOA) is applied.

The invention also refers to a method for computing the appropriate counterdiabatic driving term (CD term) by means of NC computation using a combination of symbolic and numerical calculations as described herein when solving the optimization problem. In this method, a computer aided implementation determines a suitable CD term for solving the optimization problem. Given the complexity of finding a set of operations that approximates the NC operator as a combination of CD terms (being those represented as one and two qubit operators from the set of hardware available operations), heuristic methods based on progressive improvements by term addition are the ones that choose the final design that approximates the ideal NC operator.

This CD term composition can be done by extracting from the matrix form given by NC numerical calculations the appropriate set of Pauli matrix tensor products that will produce said NC computed CD terms in a faithful manner, using reinforcement learning techniques that reward those selections that benefit the overall outcome.

In further embodiments, the invention refers to a method wherein a digitized-counterdiabatic quantum approximate optimization algorithm (DC-QAOA) is applied, in particular wherein a canonical QAOA method is enhanced by a third operator defined as the CD operator. In further embodiments,—a quantum approximate optimization algorithm (QAOA) is applied as an approximator to the digitized adiabatic evolution.

In another aspect, the invention refers to a method, in particular a computer-implemented method for determining a counterdiabatic driving term (CD term), in particular for use in a method described above and herein wherein a computer aided technique is capable of deriving the CD terms up to an order l so that, without requiring an exact term, is able to approximate is digitized version as a combination of Pauli operators.

In another aspect, the invention refers to a computer program having a program code for performing the method of one of the before mentioned claims, when the computer program is executed on a computer, a processor, a quantum-processing unit and/or a programmable hardware component.

In another aspect, the invention refers to a computation device comprising: an interface for communicating with a quantum-processing unit; and one or more processors configured to perform the before mentioned method using the quantum-processing unit.

In another aspect, the invention relates to a data processing apparatus/device/system comprising means for carrying out the method of the invention as described herein.

In particular, the invention relates to a system for performing the method of the invention as described herein, comprising
a quantum processor,
a memory to save the results of the measurements of expectation values of a final Hamiltonian (i.e. the solution to the problem), and
a classical processor for performing a classical optimization

In another aspect, the invention relates to a computer program (product) comprising instructions which, when the program is executed by a computer, cause the computer to carry out the method of the invention as described herein.

In another aspect, the invention relates to a computer-readable data carrier having stored thereon said computer program (product).

In another aspect, the invention refers to an apparatus comprising: a quantum device; and one or more computing devices communicatively coupled with the quantum device; the one or more computing devices being configured to at least cause the apparatus to: provide a quadratic unconstrained binary optimization problem defined by an equation with a cost function for optimization (for example optimizing an asset portfolio); and introduce a first set of data into the problem, the first set of data comprising historical financial data for a first period of time, the historical financial data at least comprising prices of considered assets; the quantum device being configured to at least cause the apparatus to solve the quadratic unconstrained binary optimization problem for the first period of time, thereby obtaining optimal trading trajectories for the first period of time; and the one or more computing devices being configured to at least further cause the apparatus to: provide a quantum or classical machine learning algorithm that provides a recommended composition of an asset portfolio based on a set of inputs; train the machine learning algorithm by both inputting the optimal trading trajectories obtained by the quantum device for the first period of time and minimizing a predetermined error function for each time unit of the first period of time for which there is historical financial data in the first set of data; introduce a second set of data into the machine learning algorithm, the second set of data comprising financial data for a second period of time that is posterior to the first period of time, the financial data at least comprising prices of the considered assets; and provide a recommended portfolio composition for the second period of time by running the trained machine learning algorithm with the second set of data introduced therein.

### Definitions

A final Hamiltonian (also referred to here as problem Hamiltonian) is the Hamiltonian that is addressing a time t=T in adiabatic quantum computing, quantum annealing, and by quantum annealers. The ground state of this Hamiltonian codifies the solution of an optimization problem.

A schedule function is a function that interpolates the initial and final Hamiltonian in adiabatic quantum computing and quantum annealing, and needs to be experimentally realizable by a quantum annealer.

Parameters are tunable if they are experimentally manipulable during an experiment.

An expectation value is the mean value obtained after an experimental measure of a physical quantity several times in a quantum experiment.

A quantum processor is a programmable quantum devices composed of several informational units (qubits) that can be tuned in order to perform quantum algorithms.

Ising-Hamiltonian refers to a Hamiltonian such that it can be represented by variables in {−1, 1}regime and that only considers single term coefficients (ex: c0*x0) and two-body interactions (ex: J01*x0*x1).

The cost function is the function to be minimized whose cost should render the minimum possible value when optimal solution is found. Being the optimal solution, a given configuration of available attributions to x variables.

Constraints are the set of conditions the final solution should meet in order to render a plausible one. For the case of QUBO a known constraint would be that variables are integers of 0 or 1 value. These constraints may change according to different problems but for the case of portfolio optimization budget constraint is always present as the selection should not exceed the aforementioned budget upon summation of all costs associated to selected assets.

Digitized counterdiabatic driving is the version in which CD terms composed by operations on X, Y and Z axis available in qubit regime are taken to their digital version in gate-based devices.

A given parameterized circuit design is the condition of a set of digital gate operations driven by a parameter that needs to be found in order to fit a given purpose.

Minimum depth represents the minimum set of gates that can be stacked in order to achieve the given purpose. A given Hamiltonian can be achieved by different combination of gated operations but as the noise tends to accumulate as more gates are added, is particularly convenient for realistic approaches that the digitized version meets minimum number of sequential operations to represent a given Hamiltonian.

Quadratic Unconstrained Optimization Problem (QUBO) is a problem that meets a specific shape so that all variables are binary, it counts with no constraints and the objective function is rendered by a multiplication between those variables and a set of coefficients that upmost relates two of the variables (hence, quadratic).

Initial Hamiltonian refers to the choice of a simple Hamiltonian whose minima or ground state is easy to compute in order to initiate an adiabatic problem.

Problem Hamiltonian refers to the target Hamiltonian obtained from the QUBO representation of a problem, whose ground state or minimum energy state find the solution to a given problem.

Adiabatic process is the one in which a system gets perturbed from a simplistic version of a problem to a much richer one, so that the solution found in the initial easy case gets transferred to the solution of the second, and harder, instance. This process gets the name after the Adiabatic theorem that states how this process should be delivered.

Counterdiabatic driving term (CD term) is the term able to accelerate an adiabatic process so that is suppresses all non-adiabatic transitions of the minimum energy state.

Higher-order counterdiabatic driving term refers to counterdiabatic terms that in order to be defined require the interaction of more than two (2) variables for a given problem.

Nested Commutator (NC) approach is a method that allows for the approximation of exact CD terms for a given time-dependent Hamiltonian.

Quantum Approximate Optimization Algorithm (QAOA) is a specific design inherited from the adiabatic evolution so that it gets digitized and can be used in digital gated devices to solve a complex optimization problem.

Digitized-counterdiabatic quantum approximate optimization algorithm (DC-QAOA) refers to the extension of the canonical QAOA evolution by the addition of a CD term so that the total depth of the generated circuit solving a problem gets reduced.

Reinforcement learning refers to the family of techniques that adapts a given set of operations based on their outcome when tackling a problem. That way the system is capable to learn on the actions that produce a higher profit, such as the ideal candidate designs for a quantum circuit when a problem with specific characteristics is presented.

### FIGURES

FIG. 1 Histogram depicts the ground state success probability for 1000 randomly chosen instances of the portfolio optimization problem with and without CD driving. Up to 16 qubit systems with different number of assets (n) and partitions (g) were considered. The parameters are, total evolution time T=1, and the step size dt=0.1.

FIG. 2 The upper plot depicts the success probability enhancement ratio (Eq. 12), and the lower plot represents the enhancement ratio (Eq. 11) for various system sizes. The error bars represent the standard deviation.

FIG. 3 Success probability as a function of total evolution time T for randomly chosen 40 instances is depicted. Here, n=5 assets and g=3 partitions resulting in system size N=15 were considered. A substantial improvement in success probability is obtained for most of the instances by including the local CD term

$${H}_{CD} = \dot{λ} {{\sum }_{i}^{N}}_{} {α}_{i} ( t ) {σ}_{i}^{γ} .$$

FIG. 4 Success probability as a function of the number of layers (p) for n=3 and g=2 comparing performances of DC-QAOA and QAOA with embodiments of Digitized Adiabatic Quantum Computing with CD driving. Results shown are the average of top 10 out of 20 random parameter initializations. Blue and orange bars show results of QAOA and DC-QAOA, respectively. Error bars represent standard deviation.

### EXAMPLES

The method of the invention is described here in different embodiments.

In particular, the advantages of the Digitized Adiabatic Quantum Computing and CD term based ansatz are shown.

As an example, for the method of the invention, the Markowitz portfolio optimization problem is investigated, a common problem used intensively by financial asset managers. This problem deals with how to optimize the weights of the assets in a portfolio to give out returns based on the requirements of the asset manager (for instance, maximum return, and minimal risk).

### I. Digitized Counterdiabatic Driving

To find the ground state of the Hamiltonian in Eq. 4, one follows the adiabatic theorem by starting with an initial Hamiltonian whose ground state can be easily prepared, and slowly turn on the problem Hamiltonian. The corresponding total Hamiltonian is given by

$${H}_{ad} ( λ ) = ( 1 - λ ) {H}_{i} + λ {H}_{p} , \qquad ( 6 )$$

where λ is a time dependent scheduling function. The inventors choose the initial Hamiltonian as Hᵢ=Σᵢ^{N}h^{x}σᵢ^{x}, whose ground state |ψ(0) [symbol] =2^{-N/2}(|0 [symbol] +|1 [symbol] )^{⊗N} can be easily prepared. If the evolution is slow enough, the adiabatic theorem guarantees that the final state will have a large overlap with the ground state of the problem Hamiltonian. In principle, to obtain the ground state with a higher success probability, one has to consider the total evolution time T much larger than the minimum energy gap Δₘᵢₙ between the ground state and the first excited state during the evolution. However, in practice, the adiabatic evolution due to limited coherence time, and device noise may need to be substituted with. One has to consider a short time evolution that will lead to non-adiabatic transitions between the eigenstates. In order to suppress these transitions, a technique called Shortcuts to Adiabaticity was developed and may be used in certain embodiments of the invention. According to the invention, an additional term called counterdiabatic driving term (CD term) is added into the shape of equation 6 as it can be seen in equation 7, so that the excitations due to the finite time evolution will be compensated, and the resulting evolution will be quasi adiabatic. The modified Hamiltonian by adding the CD term takes the form

$$H ( t ) = {H}_{ad} + \dot{λ} {A}_{λ} , \qquad ( 7 )$$

where A_{λ} is called adiabatic gauge potential that satisfies the condition [i\dot{∂}H_{ad}−[A_{λ},H_{ad}],H_{ad}]=0.

CD terms are the set of operations that combined produce the same action on a digital device as it would produce the adiabatic gauge potential on an ideal setup with no numerical limitation.

In principle, one can evolve the system very fast without any excitation by including the CD term associated with the adiabatic gauge potential. However, obtaining the exact gauge potential for a many-body system may be challenging. Also, the operator form of the CD term for a many-body system with N interacting spins generally contains non-local N-body interaction terms, which makes it experimentally challenging to realize.

To overcome this challenge, a variational method can be used in certain embodiments of the method of the invention to obtain an approximate CD term. The main advantage of such a method is that the approximate local CD terms can be easily implemented and its calculation does not require any knowledge of the instantaneous eigenstates. This feature makes it suitable for adiabatic quantum computation.

For the Hamiltonian (4), the local CD term of the form Ã_{λ}=Σᵢ^{N}αᵢ(t)σᵢ^{y} is chosen. Here, the CD coefficient αᵢ(t) is obtained by minimizing the action S=Tr[G_{λ}²], where G_{λ}=∂_{λ}H_{ad}+i[Ãλ, H_{ad}]

$${α}_{i} ( t ) = - \frac{{h}^{x} {h}_{i}^{𝓏}}{2 ( {{h}^{x 2} [ λ - 1 ]}^{2} + {λ}^{2} [ {{h}_{i}^{𝓏}}^{2} + {\sum }_{i \neq j} {J}_{ij}^{2} ] )} . \qquad ( 8 )$$

The CD term should vanish at the beginning and end of the protocol, for that the inventors considered the scheduling function

$$λ ( t ) \text{?} = {sin}^{2} [ \frac{π}{2} {sin}^{2} ( \frac{π i}{2 T} ) ]$$

$$\text{?} \text{indicates text missing or illegible when filed}$$

also \dot{λ}, and \ddot{λ} vanishes at t=0 and t=T. The time evolution by including the CD term is given by,

$$\vert ψ ( T ) 〉 = 𝒯 {ℯ}^{- i {\int }_{0}^{T} H ( t ) dt} \vert ψ ( 0 ) 〉 = U ( 0 , T ) \vert ψ ( 0 ) 〉 \qquad ( 9 )$$

For the gate-model implementation of the evolution, the total Hamiltonian, in certain embodiments of the invention, is written as sum of 2-local terms, i.e. H(t)=Σⱼcⱼ(t)Hⱼ(t). The total time was discretized into M parts with step size Δt=T/M. Using the Trotter-Suzuki formula, the time evolution operator was approximated as

$${U}_{dig} ( 0 . T ) = {\prod }_{k = 1}^{M} {\prod }_{j} exp \{ - i Δ {tc}_{j} ( k Δ t ) {H}_{j} \} . \qquad ( 10 )$$

In this example, the inventors only considered first order trotterization that leads to an error of the order O(Δt²). Using single qubit and two qubit gates, each matrix exponential term in Eq. 10 can be easily implemented in other embodiments of the invention. Since the Hamiltonian involves all to all connection between the qubits, additional swap gates might be needed on a device with only nearest neighbor interactions.

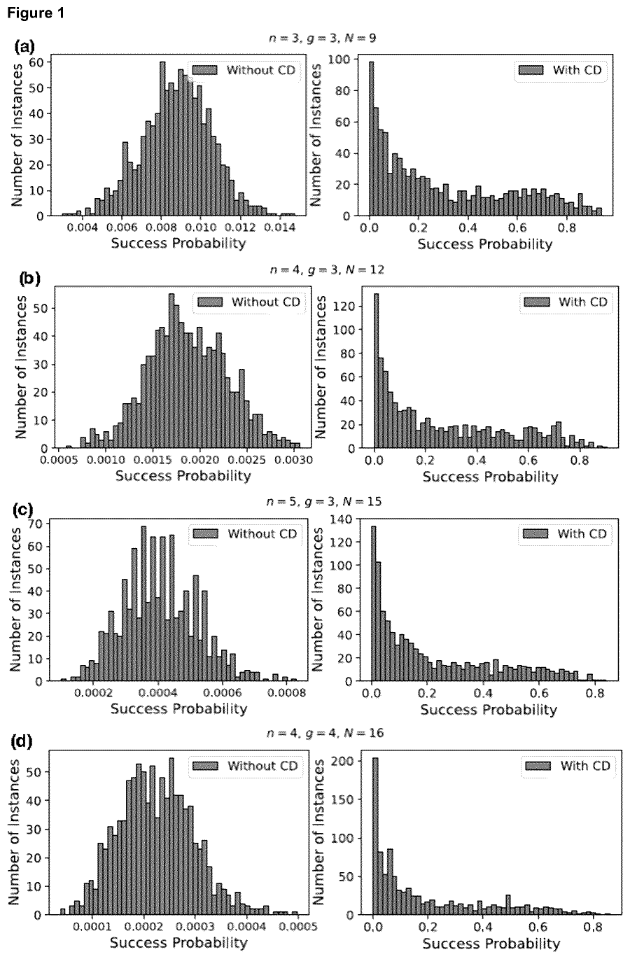

Since the NISQ devices can only implement circuits of limited depth, a short time evolution is considered and a comparison is made between the final success probability with and without including the CD term. In FIG. 1, the ground state success probability for 1000 randomly chosen instances of the portfolio optimization problem is depicted. The inventors fix the total evolution time T=1, and step size Δt=0.1 with a total 10 trotter steps. Considered is the local CD term H_{CD}=\dot{λ}Σᵢ^{N}αᵢ(t)σᵢ^{y}.

In order to quantify the enhancement by including the CD term, a metric called enhancement ratio is defined,

$${R}_{enh}^{𝒶} = \frac{{I}^{α}}{{I}^{0}} \text{?} \qquad ( 11 )$$

$$\text{?} \text{indicates text missing or illegible when filed}$$

where I⁰ is the total number of instances considered, and I^{α} denotes the number of instances with enhanced success probability by including the local CD term.

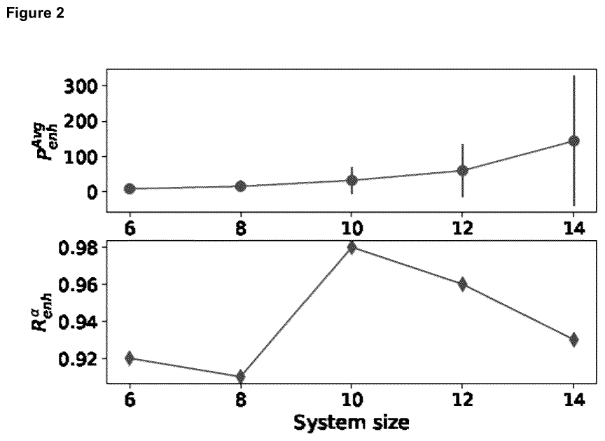

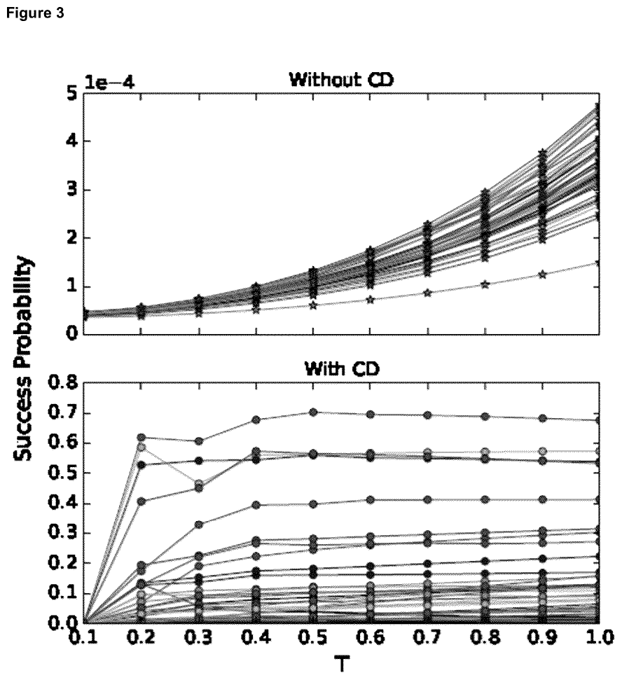

The enhancement that results from applying the local CD term is represented by the success probability enhancement,

$${p}_{enh}^{𝒶} = \frac{{p}^{α}}{{p}^{0}} \text{?} \qquad ( 12 )$$

$$\text{?} \text{indicates text missing or illegible when filed}$$

where P^{α} is the success probability by including the CD term, and P⁰ is the success probability obtained by naive evolution without the CD term. FIG. 2 depicts the average success probability enhancement and enhancement ratio for various system sizes by including the CD driving. The simulation result indicates that the enhancement with the CD term will increase with increase of the system size. In FIG. 3, the ground state success probability as a function of total evolution time T is shown. The result shows that a huge enhancement can be obtained for few instances. For some specific cases the order in which this Nested Commutator technique is required to be trimmed is necessary as not all problem instances may show the same energy gaps for their adiabatic evolution. Higher order CD terms obtained by the nested commutator (NC) ansatz by setting larger l values in following,

$${A}_{λ}^{( l )} = i {\sum }_{k = I}^{l} {α}_{k} ( t ) {\underbrace{[ {H}_{ad} , [ {H}_{a d} , … … [ {H}_{ad} ,}}_{2 k - 1} {\partial }_{λ} {H}_{ad} ] ] ] . \qquad ( 13 )$$

where, l corresponds to the expansion order, and when l→∞ one will get the exact gauge potential. Exact terms apart from being computationally expensive may be complicated to represent when this gauge potential gets digitized as a combination of Pauli operators.

By expanding the value for l and computing the digitized version of the gauge potential the method finds an equilibrium between numerical precision and acceleration of the adiabatic process.

### II. Digitized-Counterdiabatic Quantum Approximate Optimization Algorithm (DC-QAOA)

Hybrid quantum-classical optimization algorithms like QAOA have been of interest due to their applicability in the noisy intermediate-scale quantum (NISQ) era. These algorithms fall under the class of variational algorithms where classical optimization routines are employed to find suitable parameters (γ, β) that minimize or maximize an expectation value [symbol] ψ_{f}(γ,β)C|ψ_{f}(γ,β) [symbol] where C is the problem-specific cost function, and |ψ_{f}(γ,β) [symbol] is [symbol] given by

$$\vert {ψ}_{f} ( γ , β ) 〉 = U ( γ , β ) \vert {ψ}_{i} 〉 \qquad ( 14 )$$

where |ψᵢ [symbol] =|+ [symbol] ^{N} and

$$U ( γ , β ) = {U}_{m} \{ {β}_{p} ) {U}_{p} ( {γ}_{p} ) {U}_{m} ( {B}_{p - 1} ) {U}_{p} ( {γ}_{p - 1} ) … {U}_{m} ( {B}_{1} ) {U}_{p} ( {γ}_{1} ) . \qquad ( 15 )$$

where ρ shows the number of layers, Uₘ(β) shows the mixer term, and Uₚ(γ) shows the Hamiltonian term.

Modifications can be performed in the standard QAOA. Particularly the addition at least one term using counterdiabatic (CD) driving has shown significant improvements in finding ground-states of many-body Hamiltonians.

One of the algorithms following the same principle is the digitized-counterdiabatic quantum approximate optimization algorithm (DC-QAOA). In DC-QAOA, counterdiabatic (CD) driving is utilized to introduce an additional unitary UD(α), known as the CD term.

The form of the CD term is chosen from the operator pool A_{λ}^{(l)} obtained after performing the nested commutator (NC) method as mentioned above and herein (see also Section I.). In some embodiments of the method of the invention, instead of adding a local CD term, DC-QAOA and/or QAOA are applied to compare the success probabilities with the Digitized Adiabatic Quantum Computing method along with CD driving.

In QAOA, p-layers of a mixer term U_{b}(β)=e^{-βσ}^{ₓ} and a Hamiltonian term U_{c}(γ)=e^{-iγH}^{ₚ}, where Hₚ is given by Eq. 4, are applied alternatively to the initial state |ψᵢ [symbol] =|+ [symbol] ^{N}. In DC-QAOA, CD term U_{D}(α)=e^{-iασ}^{_{y}} is added along with U_{b}(β) and U_{c}(γ), where σ_{y} is calculated as a local first-order term from Eq. 13. Parameters (γ, β, α) are updated using a gradient descent based classical optimizer called Adagrad optimizer. A system of size N=6, specifically n=3 and g=2 is selected and the optimization for layers p=1, 3, 5 is performed.

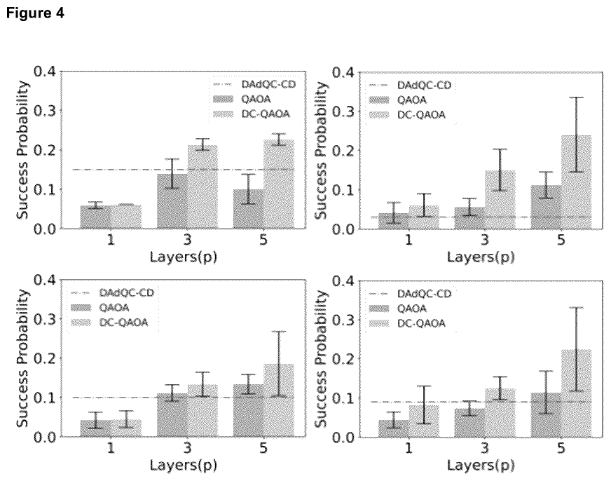

FIG. 4 shows the success probabilities (Pₛ) as the function of the number of layers (p) for four instances. Parameters (γ, β, α) are randomized initially for each instance.

It was observed that by using DC-QAOA, improvement in the Pₛ values is achieved for all the instances. Results for QAOA show that it fails to reach Pₛ values obtained using counterdiabatic driving in Digitized Adiabatic Quantum Computing methods in some instances while for some instances it shows higher Pₛ values.

Also, as expected, the performance of DC-QAOA outperforms QAOA for every instance studied. The error bars associated with DC-QAOA get larger as one goes to higher layered circuits which shows that the choice of initial parameters becomes an important factor in getting high Pₛ values.

### III. Reinforcement Learning Based Circuit Design (DC-Ansatz)

Reinforcement learning techniques have potential to find new ways in which more efficient techniques can be derived. The algorithm can infer a strategy in which a set of steps that benefit the final outcome can be derived and, therefore, a strategy be set for a particular set of problems.

By encoding this very same fact in the body of embodiments of the method of the invention, the DC-QAOA is tuned into different shapes by reorganizing the terms in a way that will increase the success probability for the solution of the initially set portfolio optimization.

The algorithm is set to choose from previously described terms, including a pool of CD terms so that at each term addition the algorithm can derive its potential outcome by a simple fitting of the parameters by the variational approaches previously set.

This algorithm meets a hierarchical structure so that all the potential terms have associated a reward to their inclusion into the final design and, thus, an ideal set of terms can be chosen when required.

Given that the algorithm chooses from the independent benefit obtained at each term (CD or problem related) the ordering in which these terms are applied is not set and therefore, more efficient circuit designs can be depicted.

In conclusion, the financial portfolio optimization problem was studied using digitized counterdiabatic algorithms. The approximate CD terms were provided by a computer by considering the variational method, which can be easily implemented on a gate-model quantum computer. The ground state success probability is compared for the evolution with and without including the CD terms by fixing the total evolution time or the number of trotter steps. Many instances of the portfolio optimization problem were considered with randomly generated data. The results indicate that the inclusion of the local CD term substantially improves the success probability.

Also, the inventors used hybrid classical-quantum algorithms for some embodiments of the method of the portfolio optimization problem. QAOA and DC-QAOA methods were used and it was shown that CD-assisted QAOA ansatz gives better performance than the naive approach.

In conclusion, the inclusion of at least one CD term gives a drastic enhancement for solving the portfolio optimization problem by finite time adiabatic evolution and also using hybrid classical-quantum algorithms. The use of at least one CD term shows great improvement.

Higher-order terms are used in certain embodiments of the invention to give further enhancement.

In this work, the inventors have demonstrated the potential of counterdiabatic (CD) driving in solving financial industry problems, such as portfolio optimization. A computer-implemented method is provided to solve the Markowitz portfolio optimization problem using adiabatic quantum optimization methods with CD driving. An unconstrained mean-variance optimization model is chosen and solved it with the digitized adiabatic evolution to compare the results with the addition of a local CD term. For randomly generated market data sets, success probabilities were plotted for various systems sizes with and without the CD term. The probability enhancement and enhancement ratio for various system sizes were also plotted.

A significant improvement in the success probabilities is observed by adding the local CD term up to the precision in which the exact CD improves in all cases but is not always needed. In some embodiments, the quantum approximate optimization algorithm (QAOA) is utilized to compare the results with digitized adiabatic evolution and also with the modified QAOA with digitized counterdiabatic driving (DC-QAOA). Success probabilities were plotted as a function of the number of layers to see that the success probabilities are improved by using these embodiments of the method.

The invention is merely suggesting a portfolio manager how to invest his budget. The investment of the budget is not part of the invention in certain embodiments.

1.-16. (canceled)

17. A computer-implemented method for solving an optimization problem, comprising:
encoding the optimization problem into an Ising-Hamiltonian model, wherein a ground state of the Ising-Hamiltonian model is a solution to the optimization problem;
providing a cost function;
providing constraints for the cost function;
applying digitized counterdiabatic driving to a Hamiltonian encoding the cost function;
providing a parameterized circuit design with a minimum depth; and
executing a time evolution until the ground state of the Ising-Hamiltonian model is computed.

18. The computer-implemented method according to claim 17, wherein the cost function encodes parameters of an optimization return, and parameters of risk data and budget data into a canonical quadratic unconstrained binary optimization form.

19. The computer-implemented method according to claim 18, wherein at least one Lagrangian multiplier is used to adjust a weight of one or more coefficients scaling a relevance of a budget constraint with respect to at least one of risk and revenue.

20. The computer-implemented method according to claim 17, wherein the constraints for the cost function are encoded by at least one Lagrangian operator.

21. The computer-implemented method according to claim 17, wherein the digitized counterdiabatic driving comprises computation of a nested commutator.

22. The computer-implemented method according to claim 17, wherein the optimization problem is an unconstrained single-period discreet mean-variance portfolio optimization problem.

23. The computer-implemented method according to claim 17, wherein the minimum depth comprises a minimum number of stacked gates.

24. The computer-implemented method according to claim 17, further comprising transforming the optimization problem into a quadratic unconstrained optimization problem.

25. The computer-implemented method according to claim 23, further comprising:
invoking a first Hamiltonian to initiate an adiabatic process; and
activating a second Hamiltonian while deactivating the first Hamiltonian, wherein the second Hamiltonian is obtained from the quadratic unconstrained optimization problem.

26. The computer-implemented method according to claim 25, further comprising modulating the adiabatic process.

27. The computer-implemented method according to claim 17, further comprising implementing a counterdiabatic driving term to compensate for excitations that occur due to the execution of the time evolution.

28. The computer-implemented method according to claim 27, wherein the counterdiabatic driving term is obtained by a nested commutator approach.

29. The computer-implemented method according to claim 27, wherein the counterdiabatic driving term is an approximation comprising a digitized combination of a plurality of Pauli operators.

30. The computer-implemented method according to claim 17, further comprising determining at least one counterdiabatic driving term.

31. The computer-implemented method according to claim 17, further comprising utilizing at least one of a digitized-counterdiabatic quantum approximate optimization algorithm and a quantum approximate optimization algorithm to solve the optimization problem.

32. A computer program having program code for performing a method comprising the steps of:
encoding an optimization problem into an Ising-Hamiltonian model, wherein a ground state of the Ising-Hamiltonian model is a solution to the optimization problem;
providing a cost function;
providing constraints for the cost function;
applying digitized counterdiabatic driving to a Hamiltonian encoding the cost function;
providing a parameterized circuit design with a minimum depth; and
executing a time evolution until the ground state of the Ising-Hamiltonian model is computed;
wherein the computer program is executed on at least one of a computer, a processor, a quantum-processing unit and a programmable hardware component.

33. The computer program according to claim 32, wherein the method further comprises implementing a counterdiabatic driving term to compensate for excitations that occur due to the execution of the time evolution.

34. The computer program according to claim 33, wherein the counterdiabatic driving term is an approximation comprising a digitized combination of a plurality of Pauli operators.

35. A computation device comprising:
an interface for communicating with a quantum-processing unit comprising one or more processors, wherein the one or processors are configured:
to encode an optimization problem into an Ising-Hamiltonian model, wherein a ground state of the Ising-Hamiltonian model is a solution to the optimization problem;
to provide a cost function;
to provide constraints for the cost function;
to apply digitized counterdiabatic driving to a Hamiltonian encoding the cost function;
to provide a parameterized circuit design with a minimum depth; and
to execute a time evolution until the ground state of the Ising-Hamiltonian model is computed.

36. The computation device according to claim 35, wherein the one or processors are configured to implement a counterdiabatic driving term to compensate for excitations that occur due to the execution of the time evolution.
